(19) United States
(12) Patent Application Publication
(10) Pub. No.: US 2005/0120165 A1
(43) Pub. Date: Jun. 2, 2005

(54) Multipurpose media player memory card reader

(76) Inventor: Hsien-Rong Liang, Taipei City (TW)

Correspondence Address: Hsien-Rong Liang, P.O. Box NO. 6-57, Junghe, Taipei, 235, TW

(21) Appl. No.: 10/724,696

(22) Filed: Dec. 2, 2003

(51) Int. Cl. G06F 12/00

(52) U.S. Cl. 711/103; 711/166

(57) ABSTRACT

A multipurpose media player memory card reader having a system flow that occurs upon inserting a memory card into a memory card reader slot, whereupon a circuit of the memory card reader reads data stored within the memory card or a control circuit reads data stored within memory. Multimedia data is transmitted to a multimedia player circuit and converted into sound signals for output through an outlet. When playing multimedia data the multipurpose media player memory card reader is further adapted to reciprocally connect to a computer port through a connector port of the multipurpose media player memory card reader, thereby the multipurpose media player memory card reader achieves functionality as a removable connected hard disk, whereby a user is able to save data within a memory card and memory through the multipurpose media player memory card reader.

### BACKGROUND OF THE INVENTION

(a) Field of the Invention

The present invention relates to a multipurpose media player memory card reader.

System flow occurs upon inserting a memory card being inserted into a memory card reader slot, whereupon a circuit of the memory card reader reads data stored within the memory card or a control circuit reads data stored within memory, accordingly multimedia data is transmitted to a multimedia player circuit and converted into sound signals for output through an outlet thereof. When playing multimedia data the multipurpose media player memory card reader is further adapted to reciprocally connect to a computer port through a connector port of the multipurpose media player memory card reader, thereby the multipurpose media player memory card reader achieves functionality as a removable connected hard disk, whereby a user is able to save data within a memory card and memory through the multipurpose media player memory card reader.

(b) Description of the Prior Art

A conventional card reader includes only a function to read memory cards, and a general media player device, such as a MP3 personal stereo, includes only a function to play MP3 data, these devices do not include functionality to be utilized as a medium for saving data. A user is therefore obliged to purchase other equipment, thereby adding a burden the user.

Therefore, the present invention attempts to resolve the technical difficulties existence in eliminating the foregoing disadvantages.

### SUMMARY OF THE INVENTION

Referring to FIGS. 1 and 2, which show a multipurpose media player memory card reader according to the present invention, and constructed to include a card reader A comprising an upper cover A1, a lower cover A2, and a circuit board B having main characteristics including the circuit board B laid between the upper cover A1 and the lower cover A2, screws A3 pass through screw holes A 21 of the lower cover A21 and screw holes C8 of the circuit board B, therewith fastening to a screw hole support of the upper cover A1.

The circuit board B is configured to include a card reader port C1, a control circuit C2, a card reader circuit C3, a multimedia player circuit C4, a battery C5, memory C6, memory card slots C71, C72, and C 73, a socket C9, a wireless transmitter circuit C10, a transmitter C11, and an electric power socket C12.

Main characteristics of the present invention are such that upon a memory card D being inserted into a memory card slot C71, C72, or C73, a card circuit C3 reads data within the memory card D or a control circuit C2 reads data stored within memory C6. The control circuit C2 differentiates whether or not the data is multimedia data. The multimedia data is transmitted to a multimedia player circuit C4, whereupon the multimedia data is converted to sound signals and output through an outlet C9. When playing multimedia data, the card reader port C1 of the multipurpose media player memory card reader A is also adapted to mutually connect to a compute port E, thereby the multipurpose media player memory card reader A is enabled as a removable connected hard disk, wherewith a user can utilize the multipurpose media player memory card reader A to store data within the memory card D and memory C6.

Furthermore, in usage, the wireless transmitter circuit C10 and the transmitter C11 are configured to transmit multimedia data as wireless signals, whereupon multimedia equipment of a vehicle receiving the wireless signals can play the multimedia data thereof.

A battery C5 provides electric power required when the control circuit C2 and multimedia player circuit C4 are in operation. Moreover, the card reader port C1 and a computer port may be utilized to recharge the battery C5, thereby making it unnecessary to change the battery C5.

A transformer or vehicle usage plug can be connected to the electric power socket C12, and thereon connected to a power supply socket or a vehicle cigarette lighter socket, thereby saving power consumption of the battery C5 while providing working electric power to the card reader A, and electric power to recharge the battery C5.

The card reader port C1 may be made to connect to a computer port, whereby the card reader port C1 can comprise a USB port (Universal Serial Bus), COM1/COM2 communication ports, PRINT PORT, and related ports utilized by electronic digital products.

The memory card slots C 71, C72 and C73 are compatible with CF card (Compact Flash Card), MS card (Memory Stick Card), SM card (Smart Media Card), and related medium utilized to store electronic digital data.

The Memory C6 can be RAM (Random Access Memory), DRAM (Dynamic Random Access Memory), SRAM (Static Random Access Memory)), SDRAM (Synchronous Dynamic Random Access Memory), FLASH, and related memory utilized by electronic digital products.

The wireless transmitter circuit C10 and wireless signals of the transmitter C11 are further configured to comply with AM (Amplitude Modulation) signals, FM (Frequency Modulation) signals, Bluetooth signals, IEEE 802, 11A, B (Institute of Electrical and Electronic Engineers 802, 11A, B), and related modulation carrier wave signals of wireless communication.

The Battery C5 can employ carbon zinc battery, mercury battery, lithium battery, nickel-hydrogen battery, and related batteries employed in electrical digital products.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view according to the present invention.

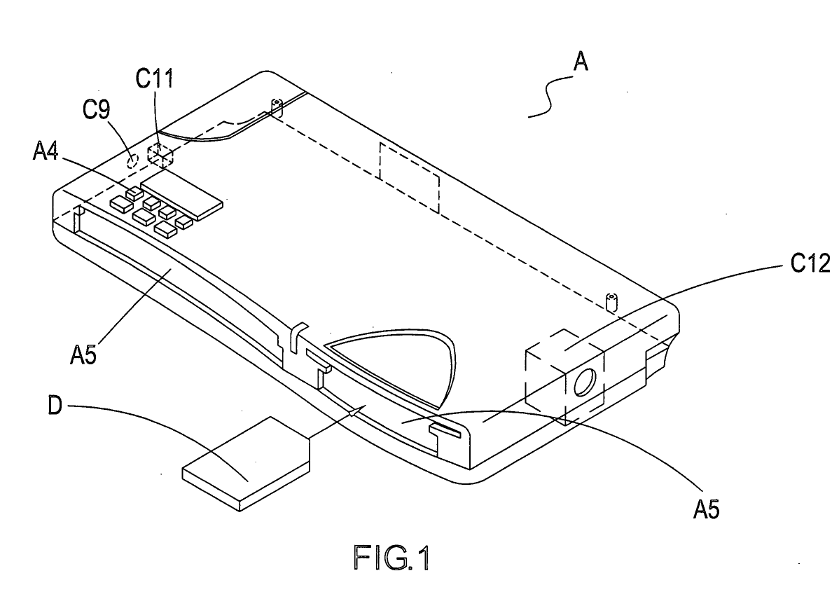

FIG. 2 shows an exploded elevational view according to the present invention.

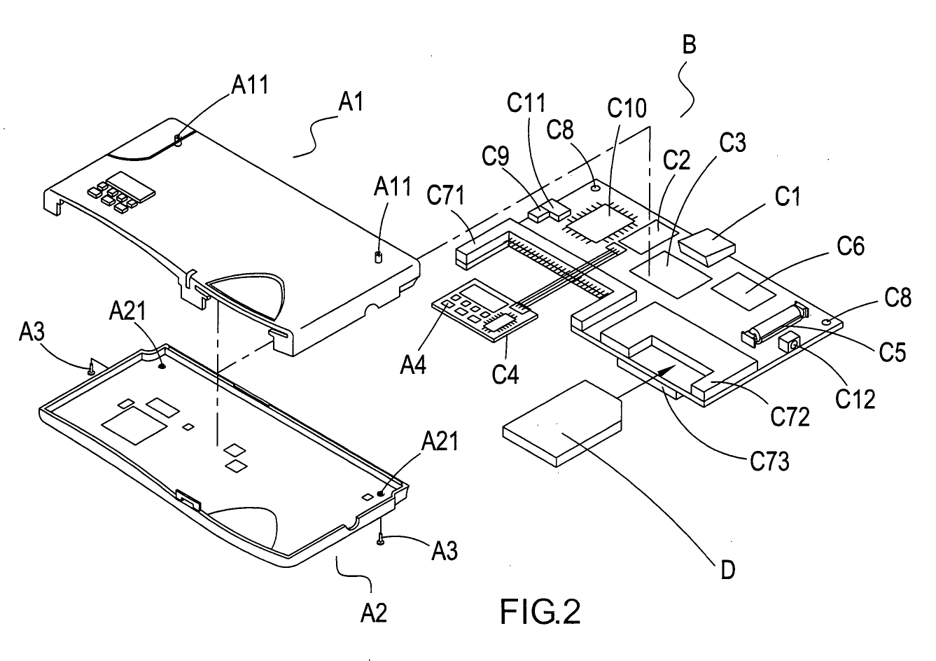

FIG. 3 shows an embodiment according to the present invention.

FIG. 4 shows another embodiment according to the present invention.

FIG. 5 shows a third embodiment according to the present invention.

### DETAILED DESCRIPTION OF THE PREFERRED EMBODIMENTS

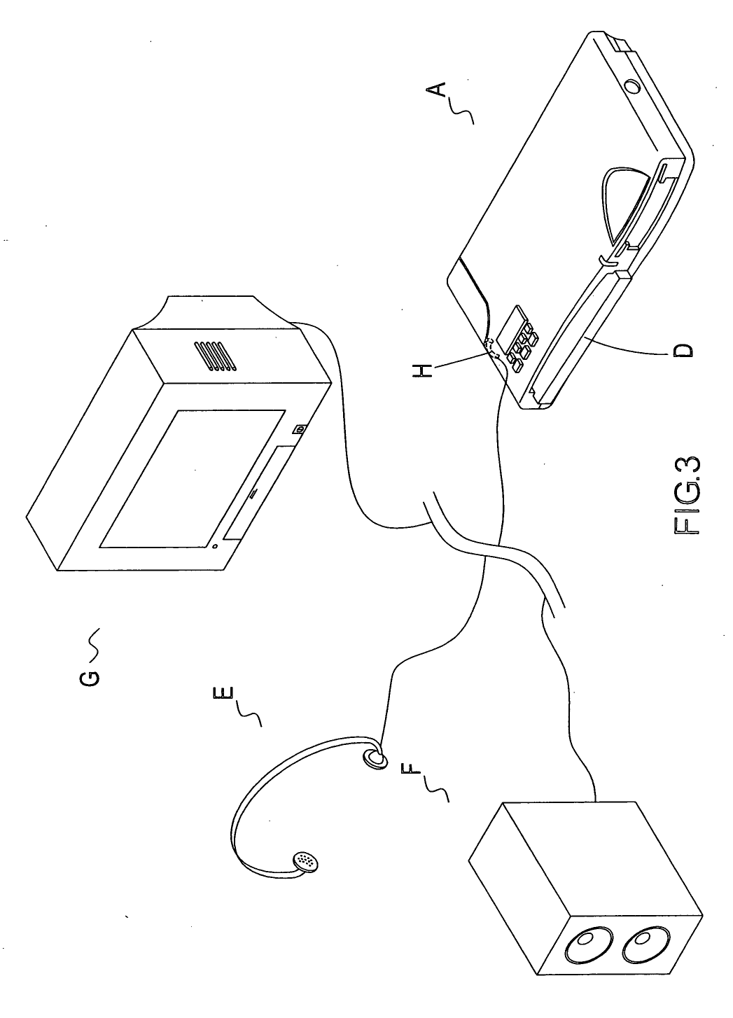

Referring to FIG. 3, which shows a preferred embodiment of the present invention comprising a multipurpose media player memory card reader. Upon a memory card D being inserted into a memory card slot A5; an interface A4 controls circuits within the card reader A, whereupon multimedia data is outputted through an outlet C7. A plug H of earphones E, speakers F, and television set G is connected to the outlet C7 of the card reader A to receive the multimedia data.

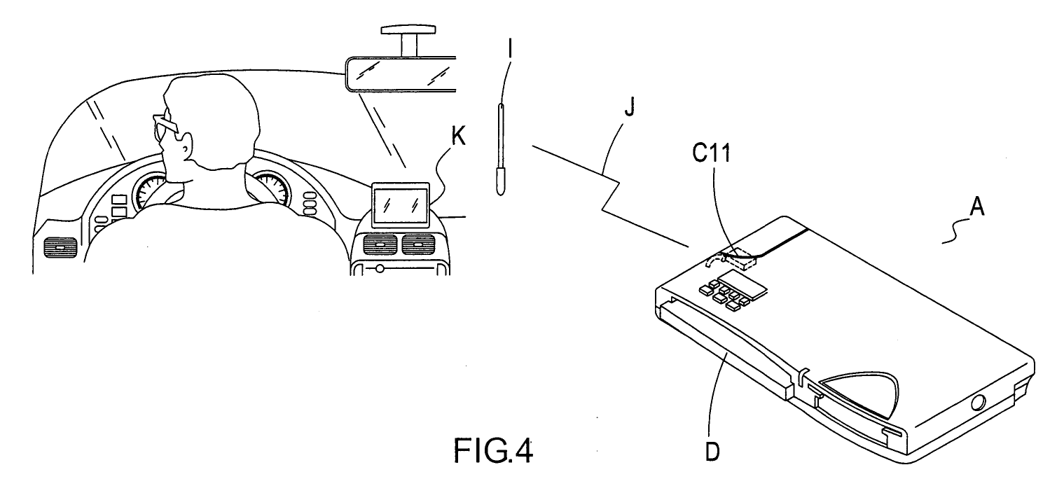

Referring to FIG. 4, which shows wireless signals J containing multimedia data being transmitted through a transmitter C11, an aerial I receives the wireless signals J, whereupon a multimedia device K within a vehicle plays the multimedia wireless signals received through the aerial I.

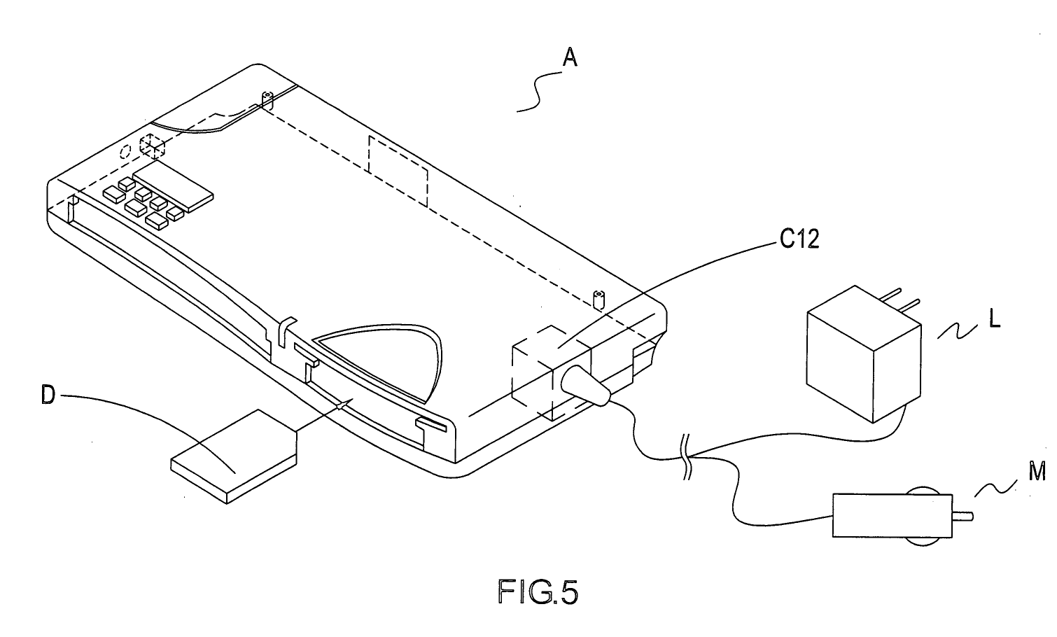

Referring to FIG. 5, which shows a battery jack socket C12 connected to a transformer L or vehicle usage socket M, whereupon the transformer L or vehicle usage socket M is plugged into a power supply socket or vehicle cigarette lighter socket, thereby saving power consumption of a battery C5, and further supplying electric power for working internal circuits, at the same time providing electric power to recharge the battery C5.

In order to further demonstrate the advancement and practicality of the present invention, comparative analysis with a conventional card reader is outlined below:

Conventional Shortcomings

1. Single function, few features.

2. Card reader is only a device for storing data.

3. MP3 personal stereo can only play MP3 data, and is unable to store data.

4. Limited compatibility with memory cards.

Advantages of the Present Invention

1. Functions as both multimedia player and card reader.

2. High compatibility with memory cards.

3. Configured to utilize a rechargeable battery function, and can be recharged through a USB connection.

4. High practicability, reduced user expense through needless purchase of other equipment.

5. Advancement and practicability.

6. Enhanced commercial competitiveness.

In conclusion, the present invention has achieved a breakthrough in prior art technology, and positively accomplished effectiveness of wished for advancement, as well as being easily understood. Furthermore, the present invention has not been made public prior to this patent application herein. Advancement and practicality of the present invention demonstrates compliance with application requirements of a new model patent, accordingly herein is proposed a new model application.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A multipurpose media player memory card reader comprising an upper cover, a lower cover, and a circuit board having characteristics such that;
the circuit board is configured to include a card reader port, a control circuit, a card reader circuit, a multimedia player circuit, a battery, memory, memory card slots, a socket, a wireless transmitter circuit, a transmitter, and an electric power socket;
a system flow occurs upon inserting a memory card into a memory card slot, the card circuit reads data within the memory card or the control circuit reads data stored within memory, the control circuit differentiates whether or not the data is multimedia data, and the multimedia data is transmitted to the multimedia player circuit, whereupon the multimedia data is converted to sound signals and output through an outlet;
when outputting multimedia data, the wireless transmitter circuit and the transmitter are configured to transmit multimedia data as wireless signals, whereupon multimedia equipment of a vehicle receiving the wireless signals can play the multimedia data thereof;
a battery provides electric power required when the control circuit and the multimedia player circuit are in operation, moreover, the card reader port connected to a compute port enables recharging of the battery, making it unnecessary to replace the battery;
when playing multimedia data, the card reader is adapted to reciprocally connect to a computer port through a connector port of the card reader, thereby the card reader achieves functionality as a removable connected hard disk, whereby a user is able to save data within a memory card and memory through the card reader.

2. The multipurpose media player memory card reader as claimed in claim 1, wherein the card reader port can comprise a USB port (Universal Serial Bus), COM1/COM2 communication ports, PRINT PORT, and related ports utilized by electronic digital products.

3. The multipurpose media player memory card reader as claimed in claim 1, wherein the memory card slots are compatible with CF card (Compact Flash Card), MS card (Memory Stick Card), SM card (Smart Media Card), and related medium utilized to store electronic digital data.

4. The multipurpose media player memory card reader as claimed in claim 1, wherein the memory can be RAM (Random Access Memory), DRAM (Dynamic Random Access Memory), SRAM (Static Random Access Memory)), SDRAM (Synchronous Dynamic Random Access Memory), FLASH, and related memory utilized by electronic digital products.

5. The multipurpose media player memory card reader as claimed in claim 1, wherein the battery can employ carbon zinc battery, mercury battery, lithium battery, nickel-hydrogen battery, and related batteries employed in electrical digital products.

6. The multipurpose media player memory card reader as claimed in claim 1, wherein the wireless transmitter circuit and wireless signals of the transmitter are further configured to comply with AM (Amplitude Modulation) signals, FM (Frequency Modulation) signals, Bluetooth signals, IEEE 802, 11A, B (Institute of Electrical and Electronic Engineers 802, 11A, B), and related modulation carrier wave signals of wireless communication.

7. The multipurpose media player memory card reader as claimed in claim 1, wherein a transformer, vehicle usage plug and related connecting equipment utilized to connect to power supply sockets can be connected to the electric power socket.
